(19) United States
(12) Patent Application Publication
(10) Pub. No.: US 2012/0188059 A1
(43) Pub. Date: Jul. 26, 2012

(54) IC TAG READING AND WRITING DEVICE, ELECTRONIC APPARATUS, AND IC TAG READING AND WRITING METHOD

(76) Inventor: Masahide Ueda, Tokyo (JP)

(21) Appl. No.: 13/393,210

(22) PCT Filed: Aug. 18, 2010
(86) PCT No.: PCT/JP2010/005094

§ 371 Date: Apr. 4, 2012

(30) Foreign Application Priority Data
Sep. 1, 2009 (JP) 2009-201885

(51) Int. Cl. G06K 7/01

(52) U.S. Cl. 340/10.1

(57) ABSTRACT

An object is to suppress an influence on an antenna and a circuit performing communication with an IC tag in which a signal excited by an antenna which does not perform communication with the IC tag is a noise source. When an IC tag reading and writing device performs communication with a first IC tag, the IC tag reading and writing device connects an antenna (210) to a first matching circuit (230) using a switching unit (260) in a communication unit (200) corresponding to a frequency of the first IC tag. In addition, the IC tag reading and writing device connects the antenna (210) to the second matching circuit (240) using the switching unit (260) in the other communication unit (200).

The application claims priority based on Japanese Patent Application 2009-201885 filed Sep. 1, 2009, the entire of which is incorporated herein.

### TECHNICAL FIELD

The present invention relates to an IC tag reading and writing device which performs reading and writing of a plurality of kinds of IC tags over a plurality of communication frequencies, an electronic apparatus, and an IC tag reading and writing method.

### BACKGROUND ART

One kind of IC tag is the Radio Frequency Identification (RFID) tag. The RFID is characterized by having a low price, but there are a plurality of standards. Within the plurality of standards, the frequency bands for performing communication are not unified. To perform reading and writing of the plurality of kinds of RFIDs with different frequency bands, it is necessary to prepare a plurality of reading and writing devices based on the frequency bands and protocols thereof.

In contrast, recently, the reading and writing of a plurality of kinds of RFIDs over a plurality of communication frequencies are being performed using one reading and writing device. For example, in Patent Document 1, it is disclosed that a reading and writing device is provided with a plurality of antennas together with a resonance circuit. Such a resonance circuit can change a resonance frequency by short-circuiting a part of the resonance circuit. In the antenna performing communication with the RFID, the resonance circuit is set such that the frequency at the time of performing the communication with the RFID is the resonance frequency. In the other antennas, the resonance circuit is set such that other frequencies are the resonance frequencies.

In Patent Document 2, it is disclosed that a variable matching circuit is provided between a transmission circuit and an antenna, to prevent the impedance of an antenna of a radio communication device such as a mobile phone from changing in response to the usage environment.

In Patent Document 3, a frequency conversion device connected to a radio communication device is disclosed. The frequency conversion device detects a transmission and reception frequency of the radio communication device, and converts the detected transmission and reception frequency into a specified frequency.

### RELATED DOCUMENT

### Patent Document

[Patent Document 1] Japanese Laid-Open Patent Publication No. 2005-339507

[Patent Document 2] PCT Japanese Patent Domestic Re-publication No. W02006-080304

[Patent Document 3] Japanese Laid-Open Patent Publication No. 2008-109371

When the reading and writing of the plurality of kinds of IC tags over the plurality of communication frequencies, for example, RFIDs are performed using one reading and writing device, there are many cases where the reading and writing device is provided with a plurality of antennas. In this case, a signal is excited even in the antennas which do not perform the communication with the IC tag that is a communication target by a response wave from the IC tag. When the plurality of antennas are configured to be small in size and distances between the individual antennas are reduced, the signal excited in the antennas which do not perform the communication with the IC tag is a source of noise which may have an influence on the antenna and circuit performing the communication with the IC tag.

### DISCLOSURE OF THE INVENTION

An object of the invention is to provide an IC tag reading and writing device, an electronic apparatus, and an IC tag reading and writing method, capable of suppressing the influence on the antenna and circuit performing the communication with the IC tag in which the signal excited by the antennas which are not performing the communication with the IC tag have become a noise source.

According to the invention, there is provided an IC tag reading and writing device which communicates with a plurality of kinds of IC tags over a plurality of communication frequencies, the IC tag reading and writing device including: a plurality of communication units that are provided according to each of the plurality of frequencies, respectively, each of the plurality of communication unit including an antenna, a transmission and reception circuit, a first matching circuit that is connected to the transmission and reception circuit and matches the antenna to the transmission and reception circuit, a second matching circuit that is connected to a load circuit and matches the antenna to
the load circuit, and a switching unit that selectively connects the antenna to any one of the first matching circuit and the second matching circuit; a signal processing unit that communicates with the plurality of kinds of IC tags through the plurality of communication units; and a switching control unit that controls the switching unit of each of the plurality of communication units.

According to the invention, there is provided an electronic apparatus used in an IC tag reading and writing device which communicates with a plurality of kinds of IC tags over a plurality of communication frequencies, the electronic apparatus including: a plurality of communication units that are provided according to each of the plurality of frequencies, respectively, each of the plurality of communication unit including an antenna, a transmission and reception circuit, a first matching circuit that is connected to the transmission and reception circuit and matches the antenna to the transmission and reception circuit, a second matching circuit that is connected to a load circuit and matches the antenna with the load circuit, and a switching unit that selectively connects the antenna to any one of the first matching circuit and the second matching circuit.

According to the invention, there is provided an electronic apparatus used in an IC tag reading and writing device which communicates with a plurality of kinds of IC tags over a plurality of communication frequencies, the electronic apparatus including: a plurality of transmission and reception circuits that are provided corresponding to a plurality of antennas provided according to each of the plurality of frequencies; a first matching circuit that is provided in each of the plurality of antennas and matches the antenna with the transmission and reception circuit corresponding to the antenna; a second matching circuit that is provided in each of the plurality of antennas and matches the antenna with the load circuit; a switching unit that selectively connects the antenna to any one of the first matching circuit and the second matching circuit; and a signal processing unit that communicates with the plurality of kinds of IC tags through the plurality of antennas and transmission and reception circuits.

According to the invention, there is provided an IC tag reading and writing method of performing reading and writing of a plurality of kinds of IC tags over a plurality of communication frequencies using one IC tag reading and writing device, wherein the IC tag reading and writing device includes a plurality of communication units that are provided according to each of the plurality of frequencies, and a signal processing unit that communicates with the plurality of kinds of IC tags through the plurality of communication units, wherein each of the plurality of communication units includes an antenna, a transmission and reception circuit, a first matching circuit that is connected to the transmission and reception circuit and matches the antenna with the transmission and reception circuit, a second matching circuit that is connected to a ground and matches the antenna with the ground, and a switching unit that selectively connects the antenna to any one of the first matching circuit and the second matching circuit, and wherein when the IC tag reading and writing device performs the communication with the first IC tag, the IC tag reading and writing device connects the antenna to the first matching circuit using the switching unit in the communication unit corresponding to the frequency of the first IC tag, and connects the antenna to the second matching circuit using the switching unit in another communication unit.

According to the invention, it is possible to suppress the influence on the antenna and circuit performing the communication with the IC tag when the signal excited by the antennas which do not perform the communication with the IC tag have become a noise source.

### BRIEF DESCRIPTION OF THE DRAWINGS

The object described above, the other objects, characteristics, and advantages will be further clarified by the preferred embodiments described below and the attached drawings.

FIG. 1 is a block diagram illustrating a configuration of an IC tag reading and writing device according to a first embodiment.

FIG. 2 is a diagram illustrating an example of a frequency band in which the IC tag reading and writing device is assumed.

FIG. 3 is a flowchart illustrating an operation of the IC tag reading and writing device shown in FIG. 1.

FIG. 4 is a block diagram illustrating a configuration of an IC tag reading and writing device according to a second embodiment.

FIG. 5 is a block diagram illustrating a configuration of an IC tag reading and writing device according to a third embodiment.

FIG. 6 is a block diagram illustrating a configuration of an IC tag reading and writing device according to a fourth embodiment.

FIG. 7 is a block diagram illustrating a configuration of an IC tag reading and writing device according to a fifth embodiment.

### DESCRIPTION OF EMBODIMENTS

Hereinafter, embodiments of the invention will be described with reference to the drawings. In all the drawings, the same reference numerals and signs are given to the same constituent elements, and the description thereof is appropriately omitted.

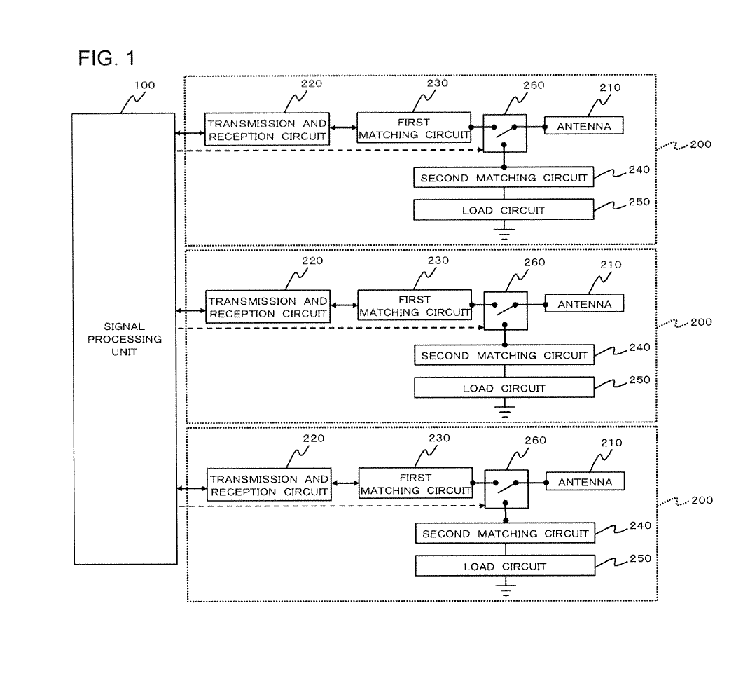

FIG. 1 is a block diagram illustrating a configuration of an IC tag reading and writing device according to a first embodiment. The IC tag reading and writing device is a device that performs communication with a plurality of kinds of IC tags over a plurality of communication frequencies, and is provided with a plurality of communication units 200 provided according to a plurality of frequencies, and a signal processing unit 100 that communicates with the plurality of kinds of IC tags through the plurality of communication units 200. Each of the plurality of communication units 200 is provided with an antenna 210, a transmission and reception circuit 220, a first matching circuit 230, a second matching circuit 240, and a switching unit 260. The first matching circuit 230 is connected to the transmission and reception circuit 220, and performs impedance matching between the antenna 210 and the transmission and reception circuit 220. The second matching circuit 240 is connected to a load circuit 250, and performs impedance matching between the antenna 210 and the load circuit 250. The switching unit 260 selectively connects the antenna 210 to any one of the first matching circuit 230 and the second matching circuit 240. The signal processing unit 100 also serves as a switching control unit that controls each switching units 260 of the plurality of communication units 200.

Specifically, for example, the plurality of antennas 210 are formed on the same dielectric substrate. The communication unit 200 other than the antenna 210 and the signal processing unit 100 are formed as one semiconductor device, for example, as one semiconductor chip. For example, the signal processing unit 100 is implemented by both software and hardware (for example, CPU and memory). For example, the transmission and reception circuit 220 is configured as an analog circuit.

The first matching circuit 230 matches impedance in a state where the corresponding transmission and reception circuit 220 is turned on to impedance of the antenna 210. In the impedance of the transmission and reception circuit 220, output impedance included in a front-end circuit in the reception circuit is dominant. For this reason, the impedance of the transmission and reception circuit 220 is very different between a state where the transmission and reception circuit 220 is turned on and a state where the transmission and reception circuit 220 is turned off. The first matching circuit 230 is designed such that transmission efficiency between the transmission and reception circuit 220 and the antenna 210 is the maximum in a state where the IC tag reading and writing device is operating.

The second matching circuit 240 matches the impedance of the load circuit 250 to the impedance of the antenna 210. The load circuit 250 has a load for consuming a noise occurred in the antenna 210, and is configured with, for example, a resistor or an LC circuit. The second matching circuit 240 is designed such that transmission efficiency from the antenna 210 to the load circuit 250 is the maximum.

The switching unit 260 is a switch having, for example, an Single Pole, Dual Throw (SPDT) function, and is formed of, for example, a semiconductor element having a switch function, for example, a PIN diode or a MESFET. The switching unit 260 is controlled by the signal processing unit 100.

The signal processing unit 100 is provided as a common processing unit for the plurality of communication units 200. The signal processing unit 100 controls any of communication unit 200 to operate in addition to the functions described above.

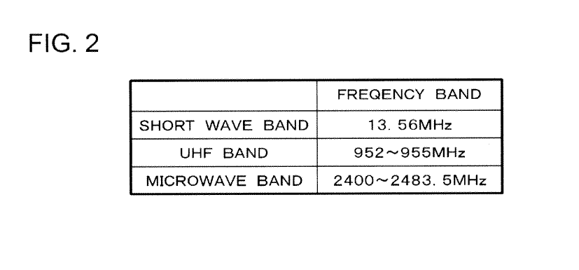

In the example shown in the drawing, the number of frequency bands in which the IC tag reading and writing device is assumed is three. As shown in FIG. 2, such frequencies are a short wave band (13.56 MHz), a UHF band (952 to 955 MHz), and a microwave band (2400 to 2483.5 MHz). As shown in FIG. 1, the number of provided communication units 200 is three. Each frequency corresponds to one or more communication protocols.

However, the frequency bands shown in FIG. 2 are examples in Japan. Such frequency bands and the number thereof are changed according to country using IC tags.

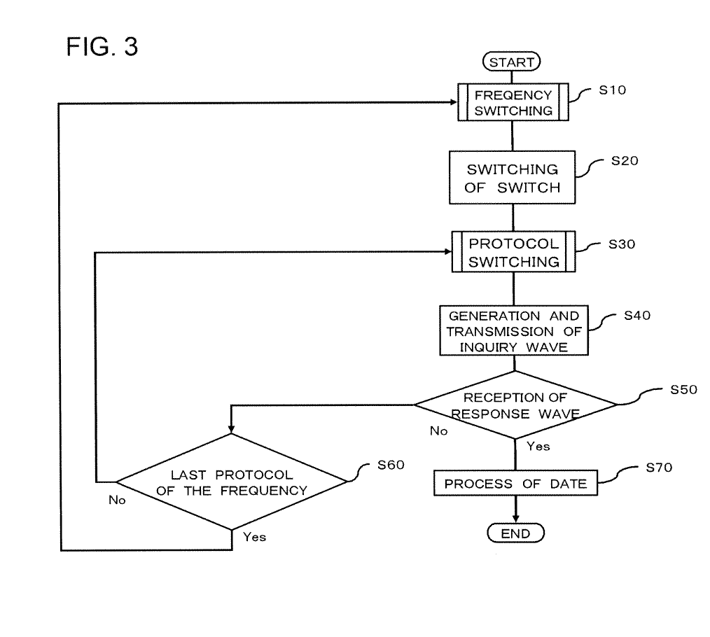

FIG. 3 is a flowchart illustrating an operation of the IC tag reading and writing device shown in FIG. 1. The process shown in the drawing represents an operation when the IC tag reading and writing device communicates with the IC tag, for example, RFID. In the example shown in the drawing, the transmission and reception circuit 220 of the communication unit 200 which does not operate is turned off for power saving.

First, the signal processing unit 100 selects a first frequency band. The signal processing unit 100 selects the communication unit 200 corresponding to the selected frequency band, turns on the transmission and reception circuit 220 of the selected communication unit 200, and turns off the other transmission and reception circuits 220. In such a manner, the signal processing unit 100 performs conversion of the frequency (Step S10).

The signal processing unit 100 controls the switching unit 260 of the communication unit 200 selected in Step S10, and connects the antenna 210 to the first matching circuit 230 in the selected communication unit 200. The signal processing unit 100 connects the antenna 210 to the second matching circuit 240 in the communication unit 200 which is not selected in Step S10. In such a manner, the signal processing unit 100 performs conversion of the switch in the switching unit 260 (Step S20).

The signal processing unit 100 selects a first protocol from the protocols corresponding to the frequency band selected in Step S10 (Step S30). The signal processing unit 100 generates an inquiry wave according to the protocol selected in Step S30 using the transmission and reception circuit 220, transfers the generated inquiry wave to the antenna 210 through the first matching circuit 230, and radiates the inquiry wave from the antenna 210 to the air (Step S40).

When the IC tag with which the IC tag reading and writing device is to communicate corresponds to the protocol selected in Step S30, the IC tag generates a response wave corresponding to the protocol and radiates the response wave to the air.

When the response wave is radiated to the air, the signal processing unit 100 and the transmission and reception circuit 220 selected in Step S10 receives the response wave through the antenna 210 (Step S50: Yes), and processes data included in the response wave (Step S70). The processed data includes a unique ID written in the IC tag and the other information.

In addition, the response wave emitted by the IC tag is received by the antenna 210 which is not selected in Step S10. For this reason, an unnecessary signal is excited by the antenna 210 which is not selected in Step S10. The unnecessary signal is consumed through the switching unit 260 and the second matching circuit 240 by the load circuit 250. For this reason, a noise is prevented from occurring in the communication unit 200 selected in Step S10 by the unnecessary signal excited by the antenna 210 which is not selected in Step S10.

When the IC tag with which the IC tag reading and writing device is to communicate does not correspond to the protocol selected in Step S30, the IC tag does not generate the response wave corresponding to the protocol. For this reason, even when a predetermined time is elapsed after the inquiry wave is radiated, the communication unit 200 selected in Step S10 does not receive the response wave (Step S50: No). In this case, when the protocol selected in Step S30 is not the last protocol at the frequency selected in Step S10 (Step S60: No), returning to Step S30, the signal processing unit 100 performs conversion of the protocol and repeats the processes described in Step S40 to Step S70. When the protocol selected in Step S30 is the last protocol at the frequency selected in Step S10 (Step S60: Yes), returning to Step S10, the signal processing unit 100 performs conversion of the frequency and repeats the processes described in Step S20 to Step S70.

Next, operations and effects of the embodiment will be described. When the IC tag radiates the response wave, the response wave is received also by the antenna 210 which is not selected in Step S10. For this reason, when the plurality of antennas are configured in small size and the distances among individual antennas are reduced, the unnecessary signal is excited by the antenna 210 which is not selected in Step S10, and the excited signal as the noise source may have an influence on the antenna 310 performing communication with the IC tag and the transmission and reception circuit 220. However, in the embodiment, the switching unit 260, the second matching circuit 240, and the load circuit 250 are provided. The unnecessary signal described above is consumed through switching unit 260 and the second matching circuit 240 by the load circuit 250. For this reason, the unnecessary signal excited by the antenna 210 which is not selected in Step S10, as the noise source is prevented from having an influence on the antenna 310 performing communication with the IC tag and the transmission and reception circuit 220.

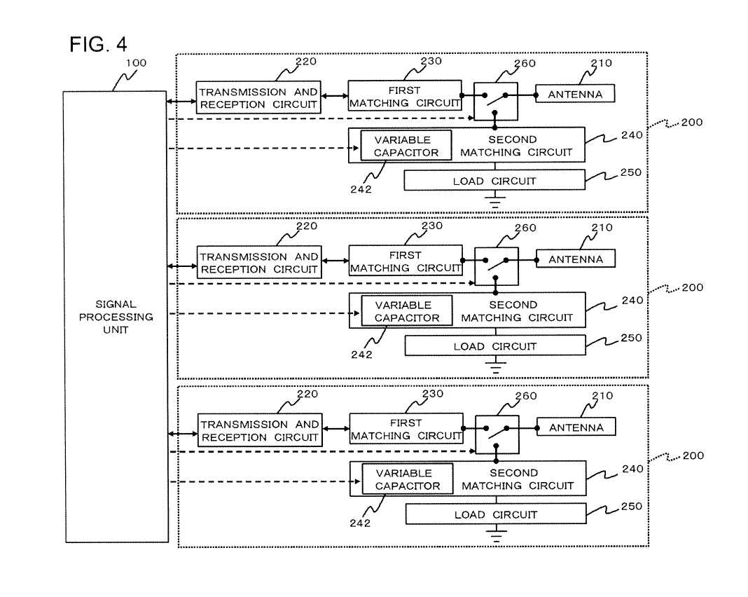

FIG. 4 is a block diagram illustrating a configuration of an IC tag reading and writing device according to a second embodiment. In the IC tag reading and writing device, the second matching circuit 240 has a variable capacitor 242, and the IC tag reading and writing device has the same configuration as that of the IC tag reading and writing device according to the first embodiment, except that the signal processing unit 100 controls a capacitance value of the variable capacitor 242.

That is, when the signal processing unit 100 tries to communicate with the IC tag at a frequency, the signal processing unit 100 connects the antenna 210 to the first matching circuit 230 using the switching unit 260 in the communication unit 200 corresponding to the frequency. In addition, the signal processing unit 100 connects the antenna 210 to the second matching circuit 240 using the switching unit 260 in another communication unit 200, controls the value of the variable capacitor 242 in another communication unit 200 according to the frequency at which the communication is tried, to match the impedances of the load circuit 250 and the antenna 210.

The operation of the signal processing unit 100 described above is performed in Step S10 of FIG. 3.

Also according to the embodiment, it is possible to obtain the same effect as that of the first embodiment. The impedance of the second matching circuit 240 maybe adjusted according to the frequency. For this reason, the unnecessary signal excited by the antenna 210 which is not selected in Step S10 is more easily consumed by the load circuit 250.

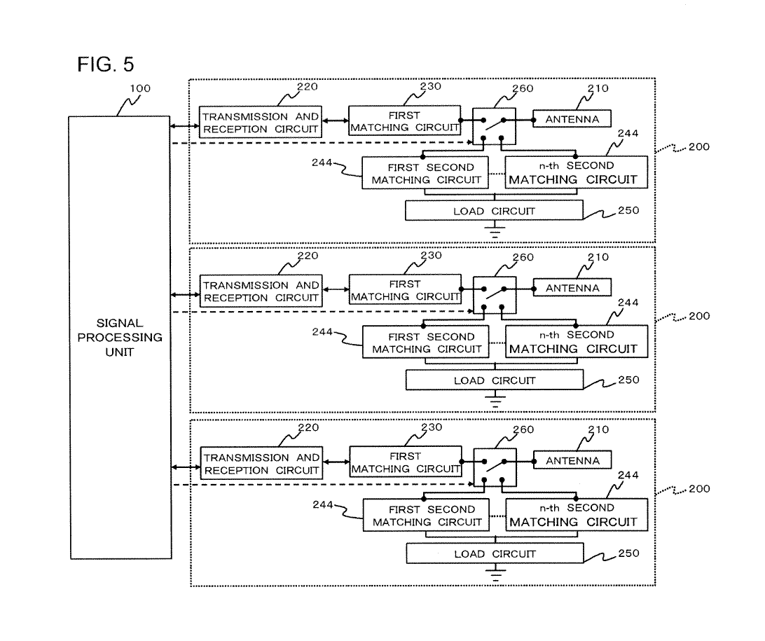

FIG. 5 is a block diagram illustrating a configuration of an IC tag reading and writing device according to a third embodiment. The reading and writing device has the same configuration as that of the IC tag reading and writing device described in the first embodiment, except for the following points.

First, the communication unit 200 has a second matching circuit 244 for each frequency which does not correspond to the communication unit 200. For example, when the IC tag reading and writing device has three communication units 200, one communication unit 200 has two second matching circuits 244. The configuration of the second matching circuit 244 is the same as the configuration of the second matching circuit 240 in the first embodiment.

For example, a case where the IC tag reading and writing device is used in Japan will be described. In the communication unit 200 corresponding to the frequency band of 13.56 MHz, one second matching circuit 244 is designed such that the impedances of the load circuit 250 and the antenna 210 are matched in the frequency band of 952 to 955 MHz, to be a complex conjugate number of the impedance at 952 to 955 MHz of the antenna 210. In addition, the other second matching circuit 244 is designed such that the impedances of the load circuit 250 and the antenna 210 are matched in the frequency band of 2400 to 2483.5 MHz, to be a complex conjugate number of the impedance at 2400 to 2483.5 MHz of the antenna 210.

In addition, in the communication unit 200 corresponding to the frequency band of 952 to 955 MHz, one second matching circuit 244 is designed such that the impedances of the load circuit 250 and the antenna 210 are matched in the frequency band of 13.56 MHz, to be a complex conjugate number of the impedance at 13.56 MHz of the antenna 210. In addition, the other second matching circuit 244 is designed such that the impedances of the load circuit 250 and the antenna 210 are matched in the frequency band of 2400 to 2483.5 MHz, to be a complex conjugate number of the impedance at 2400 to 2483.5 MHz of the antenna 210.

In addition, in the communication unit 200 corresponding to the frequency band of 2400 to 2483.5 MHz, one second matching circuit 244 is designed such that the impedances of the load circuit 250 and the antenna 210 are matched in the frequency band of 13.56 MHz, to be a complex conjugate number of the impedance at 13.56 MHz of the antenna 210. In addition, the other second matching circuit 244 is designed such that the impedances of the load circuit 250 and the antenna 210 are matched in the frequency band of 952 to 955 MHz, to be a complex conjugate number of the impedance at 952 to 955 MHz of the antenna 210.

When the signal processing unit 100 tries to communicate at the first frequency, the signal processing unit 100 connects the antenna 210 to the first matching circuit 230 using the switching unit 260 in the communication unit 200 corresponding to the first frequency. In addition, the signal processing unit 100 connects the antenna 210 to the second matching circuit 244 corresponding to the first frequency using the switching unit 260 in another communication unit 200.

The operation of the signal processing unit 100 described above is performed in Step S10 in FIG. 3.

Also according to the embodiment, it is possible to obtain the same effect as that of the first embodiment. In addition, it is possible to select the second matching circuit 244 suitable for the frequency, according to the frequency at which the communication is tried. For this reason, the unnecessary signal excited by the antenna 210 which is not selected in Step S10 is more easily consumed by the load circuit 250.

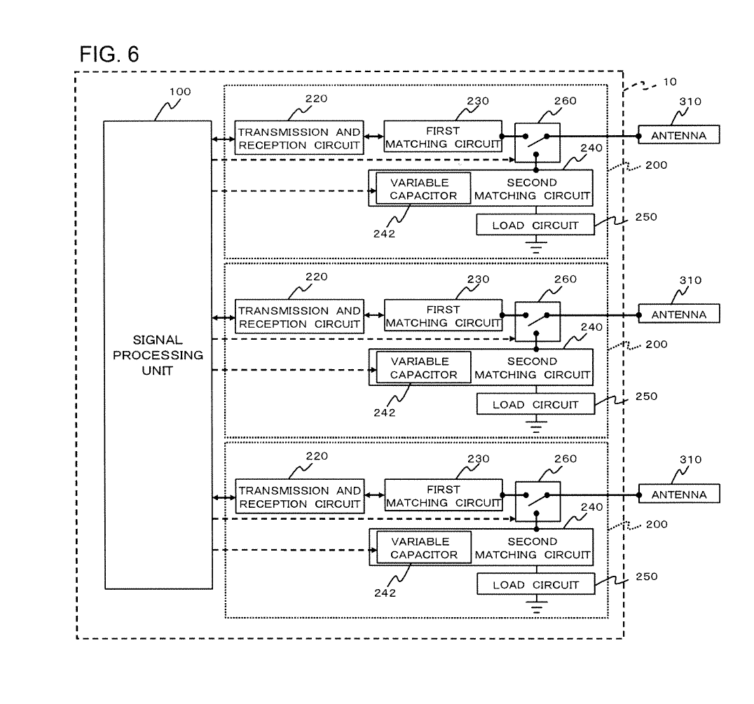

FIG. 6 is a block diagram illustrating a configuration of an IC tag reading and writing device according to a fourth embodiment. The reading and writing device, in which constituent elements other than the antenna 310 are formed in an electronic apparatus 10, has the same configuration as that of the IC tag reading and writing device according to the second embodiment, except that the antenna 310 is mounted to the electronic apparatus 10 in an external attachment manner.

That is, the electronic apparatus 10 is provided with the plurality of communication units 200 and the signal processing unit 100. The communication unit 200 includes a transmission and reception circuit 220, a first matching circuit 230, a second matching circuit 240, a load circuit 250, and a switching unit 260. The electronic apparatus 10 is formed of, for example, one semiconductor chip. The antenna 310 is connected to the semiconductor chip through a mother board or the like. The second matching circuit 240 is provided with a variable capacitor 242.

Also according to the embodiment, it is possible to obtain the same effect as that of the second embodiment. Although it is necessary to adjust the impedance of the second matching circuit 240 according to the impedance of the externally attached antenna 310, the adjustment may be performed by adjusting the capacitance value of the variable capacitor 242.

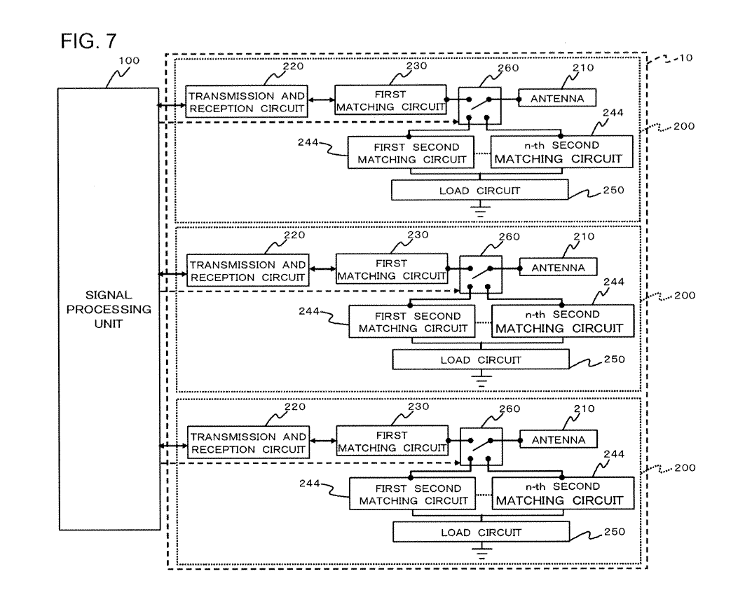

FIG. 7 is a block diagram illustrating a configuration of an IC tag reading and writing device according to a fifth embodiment. The reading and writing device has the same configuration as that of the IC tag reading and writing device according to anyone of the first to third embodiments, except that the signal processing unit 100 is externally attached to the electronic apparatus 12 formed of the plurality of communication units 200. In FIG. 7, the same configuration as the IC tag reading and writing device according to the third embodiment is shown. The electronic apparatus 12 is formed of, for example, one semiconductor chip.

Also according to the embodiment, it is possible to obtain the same effect as that of one of the first to third embodiments.

The embodiments of the invention have been described above with respect to the drawings, but they are examples of the invention, and various configurations other than the above description may be employed.

1. An IC tag reading and writing device which communicates with a plurality of kinds of IC tags over a plurality of communication frequencies, the IC tag reading and writing device comprising:
a plurality of communication units that are provided according to each of the plurality of frequencies, respectively, each of the plurality of communication unit including an antenna, a transmission and reception circuit, a first matching circuit that is connected to the transmission and reception circuit and matches the antenna with the transmission and reception circuit, a second matching circuit that is connected to a load circuit and matches the antenna with the load circuit, and a switching unit that selectively connects the antenna to anyone of the first matching circuit and the second matching circuit;
a signal processing unit that communicates with the plurality of kinds of IC tags through the plurality of communication units; and
a switching control unit that controls the switching unit of each of the plurality of communication units.

2. The IC tag reading and writing device according to claim 1, wherein the number of communication units is three or more,
wherein each of the plurality of communication units has the second matching circuits according to each of the frequencies which do not correspond to the communication unit,
wherein when the communication is performed at a first frequency, the switching control unit connects the antenna to the first matching circuit using the switching unit in the communication unit corresponding to the first frequency, and connects the antenna to the second matching circuit corresponding to the first frequency using the switching unit in the other communication unit.

3. The IC tag reading and writing device according to claim 2, wherein in each of the plurality of communication units, the impedance of the second matching circuit provided according to each of the frequencies is a complex conjugate number of impedance of the antenna of the communication unit in the corresponding frequency.

4. The IC tag reading and writing device according to claim 1, wherein the second matching circuit has a variable capacitor.

5. The IC tag reading and writing device according to claim 4, wherein the number of communication units is three or more,
wherein when the communication is performed at a first frequency, the switching control unit connects the antenna to the first matching circuit using the switching unit in the communication unit corresponding to the first frequency, and connects the antenna to the second matching circuit using the switching unit in the other communication unit, and
wherein the IC tag reading and writing device further comprises a variable capacitor control unit that controls a value of the variable capacitor in the other communication unit according to the first frequency to match the load circuit with the antenna.

6. An electronic apparatus used in an IC tag reading and writing device which communicates with a plurality of kinds of IC tags over a plurality of communication frequencies, the electronic apparatus comprising:
a plurality of communication units that are provided according to each of the plurality of frequencies, respectively, each of the plurality of communication unit including an antenna, a transmission and reception circuit, a first matching circuit that is connected to the transmission and reception circuit and matches the antenna with the transmission and reception circuit, a second matching circuit that is connected to a load circuit and matches the antenna with the load circuit, and a switching unit that selectively connects the antenna to anyone of the first matching circuit and the second matching circuit.

7. An electronic apparatus used in an IC tag reading and writing device which communicates with a plurality of kinds of IC tags over a plurality of communication frequencies, the electronic apparatus comprising:
a plurality of transmission and reception circuits that are provided corresponding to a plurality of antennas provided according to each of the plurality of frequencies;
a first matching circuit that is provided in each of the plurality of antennas and matches the antenna with the transmission and reception circuit corresponding to the antenna;
a second matching circuit that is provided in each of the plurality of antennas and matches the antenna with the load circuit;
a switching unit that selectively connects the antenna to any one of the first matching circuit and the second matching circuit; and
a signal processing unit that communicates with the plurality of kinds of IC tags through the plurality of antennas and transmission and reception circuits.

8. An IC tag reading and writing method of performing reading and writing of a plurality of kinds of IC tags over a plurality of communication frequencies using one IC tag reading and writing device,
wherein the IC tag reading and writing device includes a plurality of communication units that are provided according to each of the plurality of frequencies, and a signal processing unit that communicates with the plurality of kinds of IC tags through the plurality of communication units,
wherein each of the plurality of communication units includes an antenna, a transmission and reception circuit, a first matching circuit that is connected to the transmission and reception circuit and matches the antenna with the transmission and reception circuit, a second matching circuit that is connected to a ground and matches the antenna with the ground, and a switching unit that selectively connects the antenna to any one of the first matching circuit and the second matching circuit, and
wherein when the IC tag reading and writing device performs the communication with the first IC tag, the IC tag reading and writing device connects the antenna to the first matching circuit using the switching unit in the communication unit corresponding to the frequency of the first IC tag, and connects the antenna to the second matching circuit using the switching unit in the other communication unit.
